(19) United States
(12) Patent Application Publication
(10) Pub. No.: US 2018/0205276 A1
(43) Pub. Date: Jul. 19, 2018

(54) INTERNAL MOUNT PERMANENT MAGNET ATTACHMENT FOR ELECTRIC MACHINE

(71) Applicant: United Technologies Corporation, Farmington, CT (US)

(72) Inventors: Jagadeesh Tangudu, South Windsor, CT (US); Zaffir A. Chaudhry, South Glastonbury, CT (US)

(21) Appl. No.: 15/869,817

(22) Filed: Jan. 12, 2018

Related U.S. Application Data
(60) Provisional application No. 62/445,795, filed on Jan. 13, 2017.

(51) Int. Cl. H02K 1/30; H02K 1/27

(52) U.S. Cl. CPC H02K 1/30; H02K 2201/06; H02K 1/2753

(57) ABSTRACT

A rotor of an electric machine includes a rotor core including a rotor central core and at least one intermediate core element. A plurality of permanent magnets are located between the rotor central core and the at least one intermediate core element. The plurality of permanent magnets are secured to the rotor central core via one or more first mechanical interface connections. The one or more first mechanical interface connections are defined by a mechanical retaining feature located at one of the rotor central core or the plurality of permanent magnets, and a complimentary mechanical interface channel receptive of the mechanical retaining feature to secure the plurality of permanent magnets at the rotor central core.

### CROSS-REFERENCE TO RELATED APPLICATIONS

This application claims the benefit of Provisional Application No. 62/445,795 filed Jan. 13, 2017, which is incorporated herein by reference in its entirety.

### BACKGROUND

The present disclosure relates to electric machines. More particularly, the present disclosure relates to permanent magnet configurations for rotors of electric machines.

When rotor magnets are placed in an interior of a rotor for an electric machine, the rotor magnets are typically secured in place by elements of the rotor known as posts, which are positioned between adjacent magnets, and bridges, which are located radially outboard of the magnets and at least partially overlap the permanent magnets.

The posts and bridges, however, reduces air gap flux density due to leakage flux through the posts and bridges, resulting in a lower power density, higher operating currents of the electric machine and thus lower electric machine efficiency and higher form factor for space-constrained applications.

### BRIEF SUMMARY

In one embodiment, a rotor of an electric machine includes a rotor core including a rotor central core and at least one intermediate core element. A plurality of permanent magnets are located between the rotor central core and the at least one intermediate core element. The plurality of permanent magnets are secured to the rotor central core via one or more first mechanical interface connections. The one or more first mechanical interface connections are defined by a mechanical retaining feature located at one of the rotor central core or the plurality of permanent magnets, and a complimentary mechanical interface channel receptive of the mechanical retaining feature to secure the plurality of permanent magnets at the rotor central core.

Additionally or alternatively, in this or other embodiments the plurality of permanent magnets are arranged into one or more layers having an axial cross-sectional shape that is rectangular, U-shaped, V-shaped, C-shaped or I-shaped.

Additionally or alternatively, in this or other embodiments an axial cross-sectioned shape is skewed relative to a central axis of the rotor.

Additionally or alternatively, in this or other embodiments the rotor central core and the at least one intermediate core elements comprises a plurality of axially-stacked laminations.

Additionally or alternatively, in this or other embodiments a permanent magnet of the plurality of permanent magnets is connected to the at least one intermediate core element via one or more second mechanical interface connections. The one or more second mechanical interface connections are defined by a mechanical retaining feature located at one of the at least one intermediate core element or the plurality of permanent magnets, and a complimentary mechanical interface channel receptive of the mechanical retaining feature to secure the plurality of permanent magnets at the intermediate core element.

Additionally or alternatively, in this or other embodiments a second plurality of permanent magnets is secured to the at least one intermediate core element via one or more third mechanical interface connections. The one or more third mechanical interface connections are defined by a second mechanical retaining feature located at the least one intermediate core element or the second plurality of permanent magnets and a second complimentary mechanical interface channel receptive of the mechanical retaining feature to secure the second plurality of permanent magnets at the intermediate core element.

Additionally or alternatively, in this or other embodiments a second permanent magnet of the second plurality of permanent magnets is a radially outermost element of the rotor.

Additionally or alternatively, in this or other embodiments the second plurality of permanent magnets have a same axial cross-section shape as the plurality of permanent magnets.

Additionally or alternatively, in this or other embodiments the second plurality of permanent magnets have a different axial cross-sectional shape from the plurality of permanent magnets.

Additionally or alternatively, in this or other embodiments a radially outermost portion of the rotor is at least one cover core element.

Additionally or alternatively, in this or other embodiments a retaining sleeve is located at the outer circumference of the rotor.

In another embodiment an electric machine includes a stator, a rotor located about a rotor axis, defining an air gap between the rotor and the stator. The rotor is magnetically interactive with the stator and includes a rotor core including a rotor central core and at least one intermediate core element. A plurality of permanent magnets are located between the rotor central core and the at least one intermediate core element. The plurality of permanent magnets are secured to the rotor central core via one or more first mechanical interface connections. The one or more first mechanical interface connections are defined by a mechanical retaining feature located at one of the rotor central core or the plurality of permanent magnets and a complimentary mechanical interface channel receptive of the mechanical retaining feature to secure the plurality of permanent magnets at the rotor central core.

Additionally or alternatively, in this or other embodiments the plurality of permanent magnets are arranged into one or more layers having an axial cross-sectional shape that is rectangular, U-shaped, V-shaped, C-shaped or I-shaped.

Additionally or alternatively, in this or other embodiments an axial cross-sectioned shape is skewed relative to a central axis of the rotor.

Additionally or alternatively, in this or other embodiments a permanent magnet of the plurality of permanent magnets is connected to the at least one intermediate core element via one or more second mechanical interface connections. The one or more second mechanical interface connections are defined by a mechanical retaining feature located at one of the at least one intermediate core element or the plurality of permanent magnets, and a complimentary mechanical interface channel receptive of the mechanical retaining feature to secure the plurality of permanent magnets at the intermediate core element.

Additionally or alternatively, in this or other embodiments a second plurality of permanent magnets is secured to the at least one intermediate core element via one or more third mechanical interface connections. The one or more third mechanical interface connections are defined by a second mechanical retaining feature located at the least one intermediate core element or the second plurality of permanent magnets and a second complimentary mechanical interface channel receptive of the mechanical retaining feature to secure the second plurality of permanent magnets at the intermediate core element.

Additionally or alternatively, in this or other embodiments a second permanent magnet of the second plurality of permanent magnets is a radially outermost element of the rotor.

Additionally or alternatively, in this or other embodiments the second plurality of permanent magnets are arranged in the same orientation as the plurality of permanent magnets.

Additionally or alternatively, in this or other embodiments the second plurality of permanent magnets are arranged in a different orientation as the plurality of permanent magnets.

Additionally or alternatively, in this or other embodiments a radially outermost portion of the rotor is at least one cover core element.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is an axial cross-sectional view of an embodiment of an electric machine;

FIG. 2 is a circumferential cross-sectional view of an embodiment of rotor core for an electrical machine;

FIG. 3 is an axial cross-sectional view of a central rotor core for an electrical machine;

FIG. 4 is an axial cross-sectional view of an embodiment of an attachment of a permanent magnet to a rotor central core;

FIG. 5 is an axial cross-sectional view of a rotor including a outer rotor element;

FIG. 6 is an axial cross-sectional view of a rotor including multiple layers of permanent magnets;

FIG. 7A is a partial axial cross-sectional view of another embodiment of a rotor;

FIG. 7B is a partial axial cross-sectional view of another embodiment of a rotor;

FIG. 7C is a partial axial cross-sectional view of another embodiment of a rotor;

FIG. 7D is a partial axial cross-sectional view of another embodiment of a rotor;

FIG. 8 is a partial axial cross-sectional view of still another embodiment of a rotor;

FIG. 9A illustrates an embodiment of a permanent magnet attachment to a rotor core via a retaining element;

FIG. 9B illustrates another embodiment of a permanent magnet attachment to a rotor core via a retaining element; and

FIG. 9C illustrates still another embodiment of a permanent magnet attachment to a rotor core via a retaining element.

### DETAILED DESCRIPTION

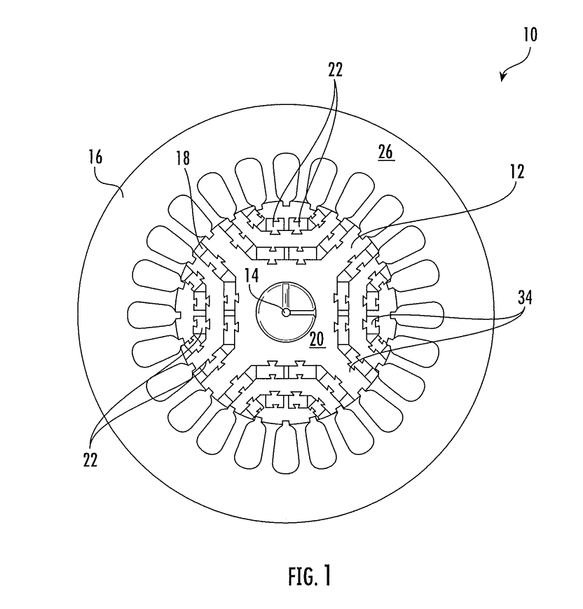

Referring to FIG. 1, an electric machine 10 includes a rotor 12 located at and rotatable about a rotor axis 14. The rotor 12 magnetically interacts with a stator 16 located, in the embodiment of FIG. 0.1, radially outboard of the rotor 12, and across an airgap 18 between the rotor 12 and the stator 16, to drive rotation of the rotor 12 about the rotor axis 14. While in the embodiment of FIG. 1, the electric machine 10 is configured such that the rotor 12 is located radially inboard of the stator 16, it is to be appreciated that in other embodiments the rotor 12 may be located radially outboard of the stator 16, while till magnetically interactive with the stator 16 across the airgap 18 between the rotor 12 and the stator 16. One skilled in the art will readily appreciate that the present disclosure may likewise be applied to such configurations.

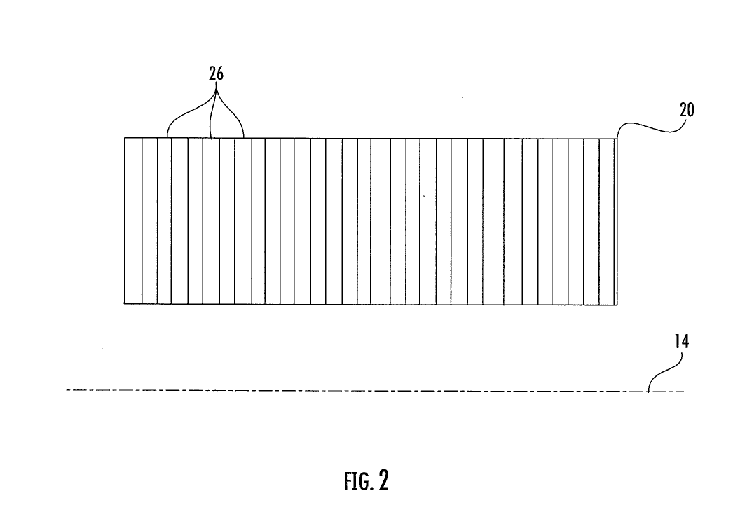

The rotor 12 includes a rotor central core 20 and a plurality of permanent magnets 22 secured to the rotor central core 20. The rotor central core 20 is located at the rotor axis 14, and in some embodiments, as shown in FIG. 2, is formed from a plurality of axially-stacked rotor laminations 26. In other embodiments, however the rotor central core 20 may be formed as a unitary element. Referring again to FIG. 1, the stator 16 includes a stator core 28 with one or more conductors (not shown) or windings disposed thereat. During operation, the one or more conductors are energized by an electrical current flowing therethrough. The current results in a magnetic field, which interacts with the plurality of permanent magnets 22 of the rotor 12 thereby causing rotation of the rotor 12 about the rotor axis 14.

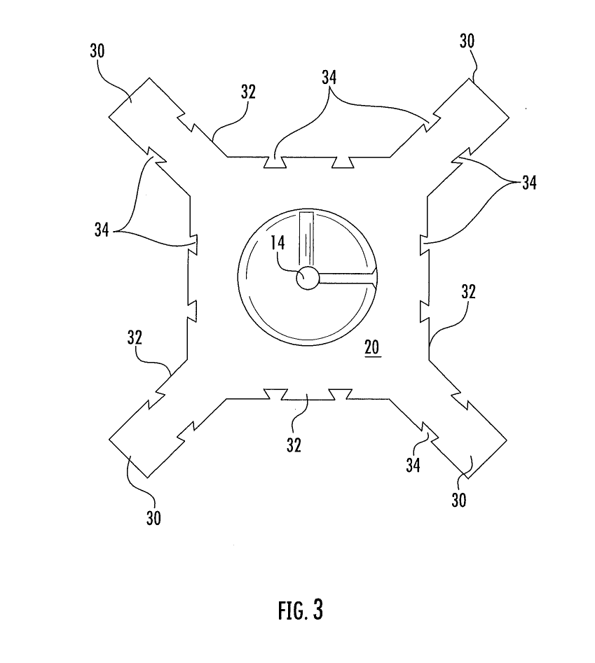

The permanent magnets 22 are installed in and secured at the rotor 12 to retain the permanent magnets thereat under centrifugal forces generated by the rotation of the rotor 12 about the rotor axis 14. An exemplary construction of the rotor 12 is illustrated in FIGS. 3-6. FIG. 3 illustrates an embodiment of a rotor central core 20. The rotor central core 20 illustrated includes four arms 30 extending radially outwardly relative to the rotor axis 14. In some embodiments, the arms 30 define magnetic pole sections of the rotor 12. It is to be appreciated, however, that in other embodiments other quantities of arms 30, for example, two or six or eight or other even number of arms 30 may be utilized. The arms 30 define a central core outer surface 32.

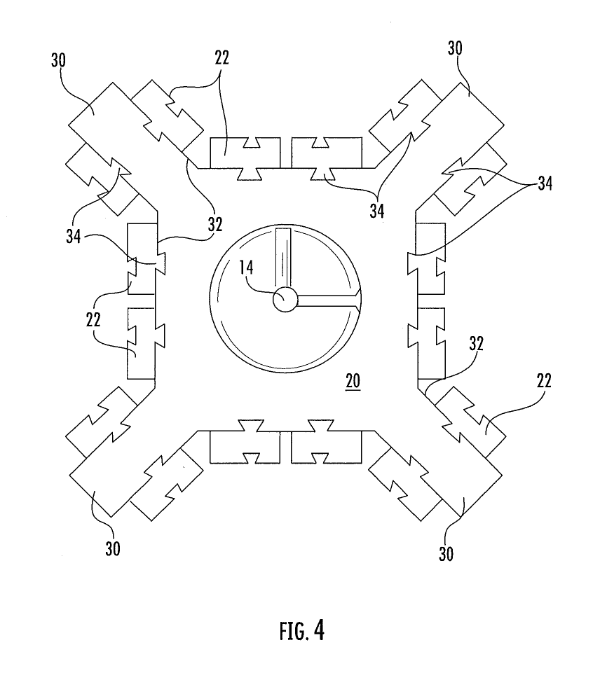

Referring now to FIG. 4, a plurality of permanent magnets 22 are installed at the central core outer surface 32 at each pole section via one or more mechanical interfaces 34, exemplary configurations of which will be discussed in more detail below. The plurality of permanent magnets 22 define a first magnet layer of the rotor 12. The mechanical interfaces 34 retain the permanent magnets 22 at the central core outer surface 32 under centrifugal forces generated by the rotation of the rotor 12 about the rotor axis 14. In some embodiments, such as in FIG. 4, a plurality of permanent magnets 22 are secured at each central core outer surface 32 to define a magnet layer, while in other embodiments a single permanent magnet 22 may be installed at the central core outer surface 32.

Referring now to FIG. 5, an intermediate core member 36 is installed over the permanent magnets 22 at each pole section, again via mechanical interfaces 34 at an intermediate core member inner surface 38. It is to be appreciated that the magnetic interface 34 configurations utilized to secure the intermediate core member 36 to the permanent magnets 22 may be the same as or different from the mechanical interface 34 configuration utilized to secure the permanent magnets to the central core outer surface 32. The intermediate core member 36 may be U-shaped as shown in FIG. 5, or in other embodiments may be V-shaped, or I-shaped layers or other shapes in an axial cross-sectional view.

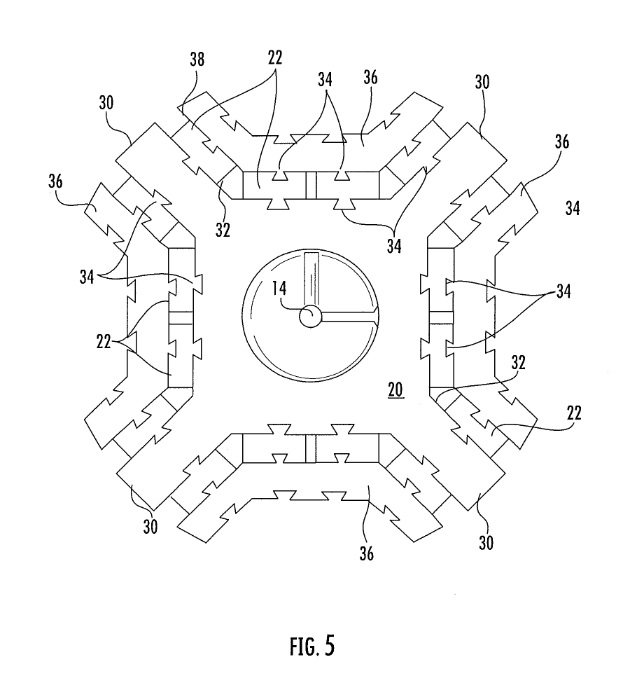

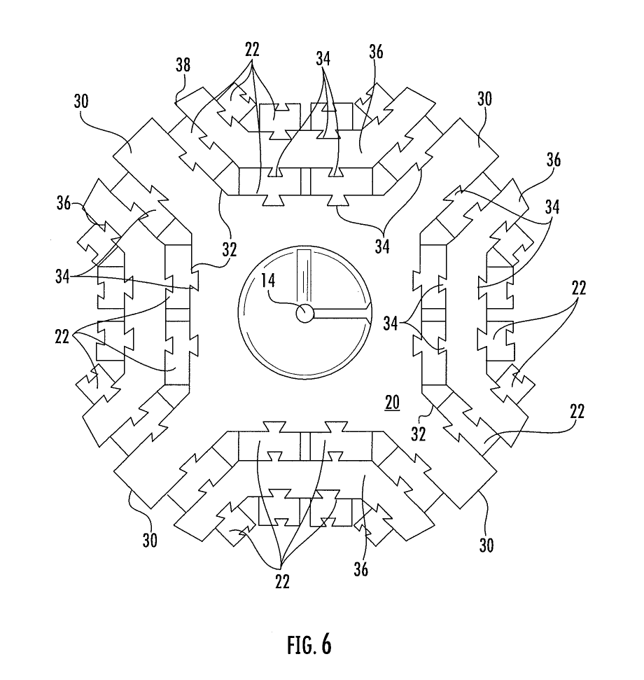

In some embodiments, such as shown in FIG. 6, a second magnet layer of permanent magnets 22 is installed at each pole section. In particular, permanent magnets 22 are installed at an outer core member outer surface 40, opposite the outer core member inner surface 38. The permanent magnets 22 are installed via mechanical interfaces 34, which may be the same as or different from the mechanical interfaces 34 utilized in installation of the permanent magnets 22 of the first magnet layer. While a first magnet layer and a second magnet layer are shown in the embodiment of FIG. 6, one skilled in the art will appreciate that additional permanent magnet layers and intermediate core members 36 may be included in the rotor 12 to expand the topology to a multi-layer rotor. Further, while in some embodiments, size and/or shape of the permanent magnets 22 is consistent, in other embodiments the permanent magnet 22 configuration may vary throughout the rotor 12.

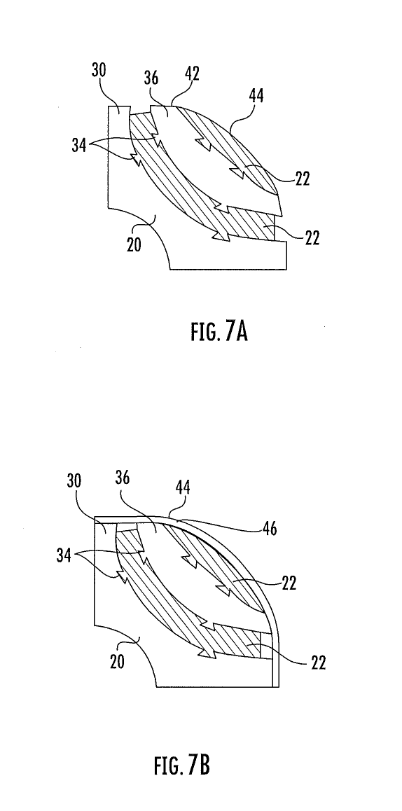

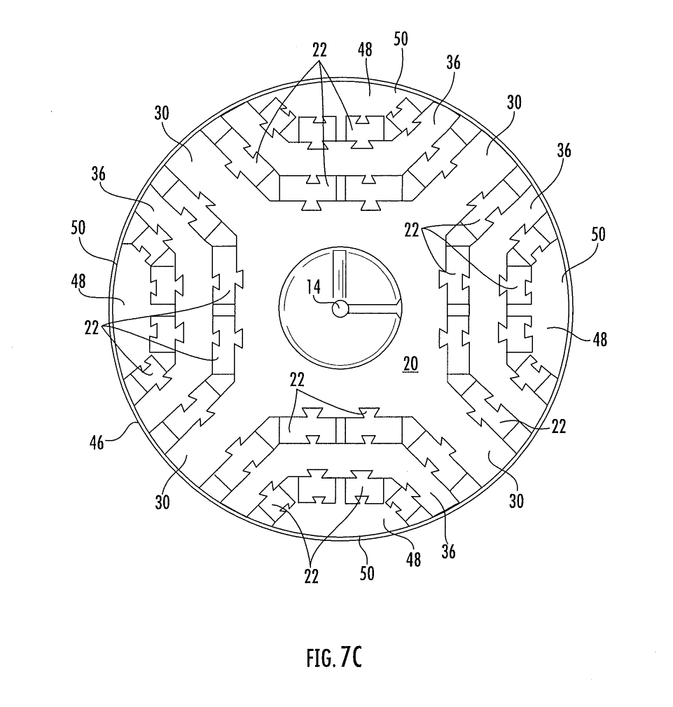

Referring now to FIGS. 7a-7d, a rotor outer perimetrical surface 42 may be one of several configurations. For example, in the embodiment of FIG. 7a, a permanent magnet 22 is positioned to at least partially define the outer perimetrical surface 42. In some embodiments, such as shown in FIG. 7a, an outer radial magnet surface 44 has a curvilinear shape to define the outer perimetrical surface 42.

Referring now to FIG. 7b, in some embodiments, the rotor 12 includes a retaining sleeve 46 located about the rotor outer radius to define the outer perimetrical surface 42. In some embodiments, the retaining sleeve 46 extends along an entire axial length of the rotor 12, while in other embodiments the retaining sleeve 46 extends only partially along the axial length. Further, a plurality of retaining sleeves 46 may be arranged along the axial length. The retaining sleeves may axially abut one another, or alternatively may define sleeve gaps therebetween. The retaining sleeve 46 may be made of, for example, carbon fiber, Inconel, metal, or any high strength, low electric conductive alloy. The retaining sleeve 46 is secured to the rotor 12 by, for example, an adhesive, by shrink-fit or any other suitable attachment means.

Referring now to FIG. 7c, the outer perimetrical surface 42 is defined by a cover core element 48 connected to a radially outermost permanent magnet 22 at each pole section. In some embodiments, such as shown, the cover core elements 48 are secured to the second magnet layer of permanent magnets 22. The cover core elements 48 are secured to the permanent magnets 22 via mechanical interfaces 34. In some embodiments, an outer cover surface 50 has a curvilinear shape to define the outer perimetrical surface 42. Similarly, in FIG. 7d, the outer perimetrical surface 42 is defined by the cover core elements 48. In the embodiment of FIG. 7d, the intermediate core members 36 and cover core elements 48 include a combination of U-shaped and V-shaped surfaces. Further, in some embodiments the rotor 12 may include retaining sleeve 46 outboard of the of the cover core elements 48.

Referring again to FIG. 4, in some embodiments, the mechanical interface 34 is a dovetail connection, in which the permanent magnet 22 includes a magnet dovetail 52 extending radially inwardly into a complimentary core dovetail 54 of the rotor central core 20. The magnet dovetail 52 and the core dovetail 54 are complimentary such that the magnet dovetail 52 is insertable into the core dovetail 54 to secure the permanent magnet 22 to the rotor central core 20. In some embodiments, the magnet dovetail 52 and the core dovetail 54 extend axially along the permanent magnet 22 and the rotor central core 20 respectively. In some embodiments, the magnet dovetail 52 may extend continuously along an entire axial extent of the permanent magnet 22, while in other embodiments the magnet dovetail 52 may be segmented along the axial extent. While in FIG. 4 each permanent magnet 22 is illustrated as having a single magnet dovetails 52, one skilled in the art will readily appreciate that other quantities of magnet dovetails 34, such as two, three or four magnet dovetails 52 may be used. In other embodiments, the configuration may be substantially reversed. In such embodiments the core dovetail 54 is inserted into the magnet dovetail 52. While the magnet dovetail 52 and the core dovetail 54 are shown in FIG. 4 as trapezoidal-shaped elements, it is to be appreciated that other shapes, such as oval or circular, or triangular or fir-tree shaped elements may be used. Further, while described in the context of the permanent magnet 22 to rotor central core 20 interface, the description of mechanical interfaces 34 may be similarly applied throughout the rotor 12.

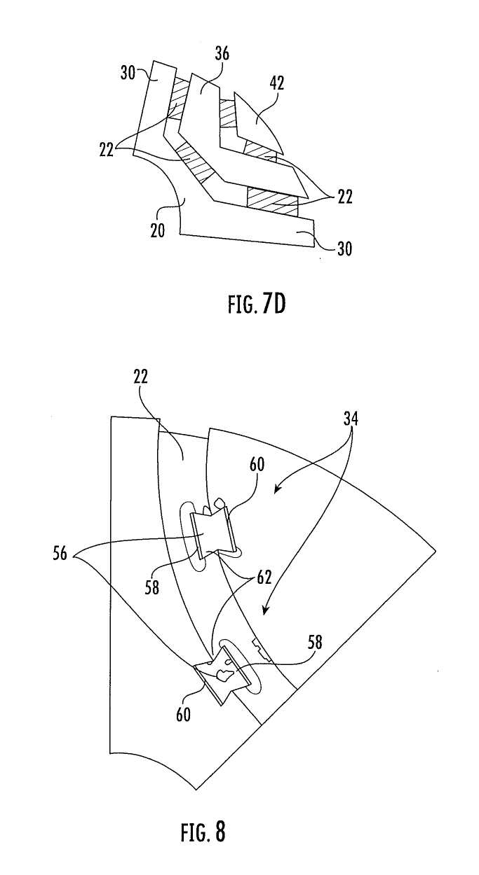

In yet other embodiments, such as shown in FIG. 8, the mechanical interface 34 may include one or more mechanical interface members 56, such as a pin element or a bow-tie element to retain the permanent magnets 22 to the rotor central core 20, or other core elements. In these embodiments, the magnet dovetail 52 extends into the permanent magnet 22 and includes a magnet channel 58. Similarly, the core dovetail 54 extends into the rotor central core 20 and includes a core channel 60. The mechanical interface member 56 includes member surfaces 62 complimentary to the magnet channel 58 and the core channel 60 to engage the mechanical interface member 56 with the magnet channel 58 and the core channel 60 when installed thereto.

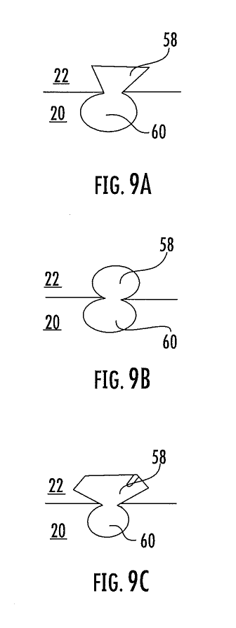

While in the embodiment of FIG. 8, the magnet channel 58 and the core channel 60 are three-sided, it is to be appreciated that in other embodiments other shapes may be utilized, having other numbers of sides and/or including curvilinear shapes. Further, in some embodiments, the magnet channel 58 and the core channel 60 may have substantially identical shapes, while in other embodiments the magnet channel 58 may be differently shaped from the core channel 60. Alternative shapes of magnet channel 58 and core channel 60 combinations, and the corresponding mechanical interface members 56 are illustrated in FIGS. 9A-9C. In FIG. 9A, the core channel 60 is a partial circular configuration, while the magnet channel 58 is three-sided. In the embodiment of FIG. 9B, both the core channel 60 and the magnet channel 58 have a partial circular configuration, and in FIG. 9C the magnet channel 58 has a five-sided configuration while the core channel 60 has a partial circular configuration. It is to be appreciated that the illustrated embodiments are merely exemplary, and that additional configurations are contemplated within the scope of the present disclosure.

The mechanical interface members 56 may be formed from, for example, a metallic or non-metallic material, a composite material, or a same material as the permanent magnet 22 depending on required mechanical properties and performance characteristics. Such mechanical interface members 56 may be unitary or segmented in, for example, a radial, axial and/or circumferential direction.

As stated, the rotor core may have multiple radial layers. As such, in some embodiments, a first core element is installed to the plurality of permanent magnets at each pole section, via a dovetail connection as previously described. Additional alternating layers of permanent magnets and core elements may also be installed. It is to be appreciated that the mechanical interface connections may be utilized instead of the post and bridge elements of prior rotor cores, or in addition to the post and/or bridge elements, in some embodiments with reduced thickness post and/or bridge elements. Further, an adhesive, filled or unfilled, may be included to aid in retention of the permanent magnets.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A rotor of an electric machine, comprising:
a rotor core including:
a rotor central core; and
at least one intermediate core element;
a plurality of permanent magnets disposed between the rotor central core and the at least one intermediate core element;
wherein the plurality of permanent magnets are secured to the rotor central core via one or more first mechanical interface connections, the one or more first mechanical interface connections defined by:
a mechanical retaining feature located at one of the rotor central core or the plurality of permanent magnets; and
a complimentary mechanical interface channel receptive of the mechanical retaining feature to secure the plurality of permanent magnets at the rotor central core.

2. The rotor of claim 1, wherein the plurality of permanent magnets are arranged into one or more layers having an axial cross-sectional shape that is rectangular, U-shaped, V-shaped, C-shaped or I-shaped.

3. The rotor of claim 2, wherein an axial cross-sectioned shape is skewed relative to a central axis of the rotor.

4. The rotor of claim 1, wherein the rotor central core and the at least one intermediate core elements comprises a plurality of axially-stacked laminations.

5. The rotor of claim 1, wherein a permanent magnet of the plurality of permanent magnets is connected to the at least one intermediate core element via one or more second mechanical interface connections, the one or more second mechanical interface connections defined by:
a mechanical retaining feature located at one of the at least one intermediate core element or the plurality of permanent magnets; and
a complimentary mechanical interface channel receptive of the mechanical retaining feature to secure the plurality of permanent magnets at the intermediate core element.

6. The rotor of claim 5 further comprising
a second plurality of permanent magnets secured to the at least one intermediate core element via one or more third mechanical interface connections, the one or more third mechanical interface connections defined by:
a second mechanical retaining feature located at the least one intermediate core element or the second plurality of permanent magnets; and
a second complimentary mechanical interface channel receptive of the mechanical retaining feature to secure the second plurality of permanent magnets at the intermediate core element.

7. The rotor of claim 6, wherein a second permanent magnet of the second plurality of permanent magnets is a radially outermost element of the rotor.

8. The rotor of claim 6, wherein the second plurality of permanent magnets have a same axial cross-section shape as the plurality of permanent magnets.

9. The rotor of claim 6, wherein the second plurality of permanent magnets have a different axial cross-sectional shape from the plurality of permanent magnets.

10. The rotor of claim 1, wherein a radially outermost portion of the rotor is at least one cover core element.

11. The rotor of claim 1 further comprising a retaining sleeve located at the outer circumference of the rotor.

12. An electric machine comprising:
a stator;
a rotor located about a rotor axis, defining an air gap between the rotor and the stator, the rotor magnetically interactive with the stator and including:
a rotor core including:
a rotor central core; and
at least one intermediate core element;
a plurality of permanent magnets disposed between the rotor central core and the at least one intermediate core element;
wherein the plurality of permanent magnets are secured to the rotor central core via one or more first mechanical interface connections, the one or more first mechanical interface connections defined by:
a mechanical retaining feature located at one of the rotor central core or the plurality of permanent magnets; and
a complimentary mechanical interface channel receptive of the mechanical retaining feature to secure the plurality of permanent magnets at the rotor central core.

13. The electric machine of claim 12, wherein the plurality of permanent magnets are arranged into one or more layers having an axial cross-sectional shape that is rectangular, U-shaped, V-shaped, C-shaped or I-shaped.

14. The electric machine of claim 12, wherein an axial cross-sectioned shape is skewed relative to a central axis of the rotor.

15. The electric machine of claim 12, wherein a permanent magnet of the plurality of permanent magnets is connected to the at least one intermediate core element via one or more second mechanical interface connections, the one or more second mechanical interface connections defined by:
a mechanical retaining feature located at one of the at least one intermediate core element or the plurality of permanent magnets; and
a complimentary mechanical interface channel receptive of the mechanical retaining feature to secure the plurality of permanent magnets at the intermediate core element.

16. The electric machine of claim 12, further comprising
a second plurality of permanent magnets secured to the at least one intermediate core element via one or more third mechanical interface connections, the one or more third mechanical interface connections defined by:
a second mechanical retaining feature located at the least one intermediate core element or the second plurality of permanent magnets; and
a second complimentary mechanical interface channel receptive of the mechanical retaining feature to secure the second plurality of permanent magnets at the intermediate core element.

17. The electric machine of claim 16, wherein a second permanent magnet of the second plurality of permanent magnets is a radially outermost element of the rotor.

18. The electric machine of claim 16, wherein the second plurality of permanent magnets are arranged in the same orientation as the plurality of permanent magnets.

19. The electric machine of claim 16, wherein the second plurality of permanent magnets are arranged in a different orientation as the plurality of permanent magnets.

20. The electric machine of claim 12, wherein a radially outermost portion of the rotor is at least one cover core element.
